(19) United States
(12) Patent Application Publication
(10) Pub. No.: US 2007/0048572 A1
(43) Pub. Date: Mar. 1, 2007

(54) Fuel cell system enclosure

(76) Inventors: Keith Oglesby, Livonia, MI (US); Steven Schondorf, Dearborn, MI (US); Milos Milacic, New Boston, MI (US); Scott Staley, Dearborn, MI (US)

Correspondence Address: TUNG & ASSOCIATES, 838 WEST LONG LAKE, SUITE 120, BLOOMFIELD HILLS, MI, 48302, US

(21) Appl. No.: 11/218,696

(22) Filed: Sep. 1, 2005

(51) Int. Cl. H01M 8/04

(52) U.S. Cl. 429/26; 429/38; 429/13

(57) ABSTRACT

A fuel cell system enclosure having an integrated condenser and muffler is disclosed. The fuel cell enclosure includes a stack module having a stack module interior for containing a fuel cell stack, a humidifier provided in fluid communication with the stack module interior, and an integrated condenser/muffler provided in fluid communication with the stack module interior. A method for operating a fuel cell system having one or more fuel cells is also disclosed.

### FIELD OF THE INVENTION

The present invention relates to fuel cells which are suitable for generating electricity for automotive or other applications. More particularly, the present invention relates to a fuel cell system enclosure having an integrated deionized water tank and condenser/muffler which reduces the plumbing requirements and enhances the package and weight efficiency and the thermal and noise insulation of the enclosure.

### BACKGROUND OF THE INVENTION

Recently, intensive research has been expended on the development of fuel cell systems to generate energy for automotive and other applications. A fuel cell system produces electricity by harvesting electrons from hydrogen gas. Oxygen is reduced by the electrons and combined with protons to produce water as a by-product. Fuel cell vehicles are highly efficient and environmentally-friendly.

In a typical conventional fuel cell system, a fuel cell stack is contained in a stack module of a fuel cell enclosure. An air intake conduit distributes air through a humidifier and into the stack module, respectively, to humidify the air and distribute the humidified air into the stack module. The humidified air ensures that the membranes in the fuel cell stack remain sufficiently moist for optimum operation. An air exhaust conduit distributes exhaust air from the stack module and then through a condenser and a muffler, respectively. The condenser removes excess moisture from the exhaust air prior to entry of the exhaust air into the muffler. All or a portion of the recovered moisture is typically distributed from the condenser, through a DI (de-ionized) water tank and back to the humidifier to increase the moisture of the air before it enters the stack module.

In the conventional fuel cell system, the condenser, the muffler and the DI water tank are separate elements. However, the design requires extra conduit to interconnect the condenser, muffler and DI water tank. Also, thermal and noise insulation of these elements are inefficient. Moreover, the design is inefficient from a packaging and weight distribution standpoint.

Accordingly, a new and improved fuel cell enclosure is needed in which the condenser and muffler elements or the condenser, muffler and DI water tank elements are integrated into a single component.

### SUMMARY OF THE INVENTION

The present invention is generally directed to a novel fuel cell enclosure having an integrated condenser and muffler or an integrated condenser, muffler and DI water tank on the outlet side of a stack module which contains a fuel cell stack. In one embodiment of the invention, an air intake conduit is disposed in fluid communication with a stack module and a humidifier is provided in the air intake module. An air exhaust conduit extends from the stack module, and an integrated condenser/muffler is disposed in fluid communication with the air exhaust conduit. A DI water tank is connected to the integrated condenser/muffler through a connecting conduit. The integrated condenser/muffler imparts enhanced package and weight efficiency, as well as enhanced thermal and noise insulation, to the fuel cell stack.

In another embodiment of the invention, the stack module includes a triple-walled stack module enclosure that contains a fuel cell stack. The stack module enclosure includes an integrated condenser/muffler and a DI water tank which surrounds the integrated condenser/muffler.

In still another embodiment of the invention, the stack module includes a double-walled stack module enclosure which defines a stack module that contains a fuel cell stack. The double-walled stack module includes inner and outer walls that define a DI water tank that is adjacent to an integrated condenser/muffler.

### BRIEF DESCRIPTION OF THE DRAWINGS

The invention will now be described, by way of example, with reference to the accompanying drawings, in which:

FIG. 1 is a schematic view of a first embodiment of a fuel cell enclosure according to the present invention; and

FIG. 2 is a schematic view of a second embodiment of a fuel cell enclosure according to the present invention; and

FIG. 3 is a schematic view of a third embodiment of a fuel cell enclosure according to the present invention.

### DETAILED DESCRIPTION OF THE INVENTION

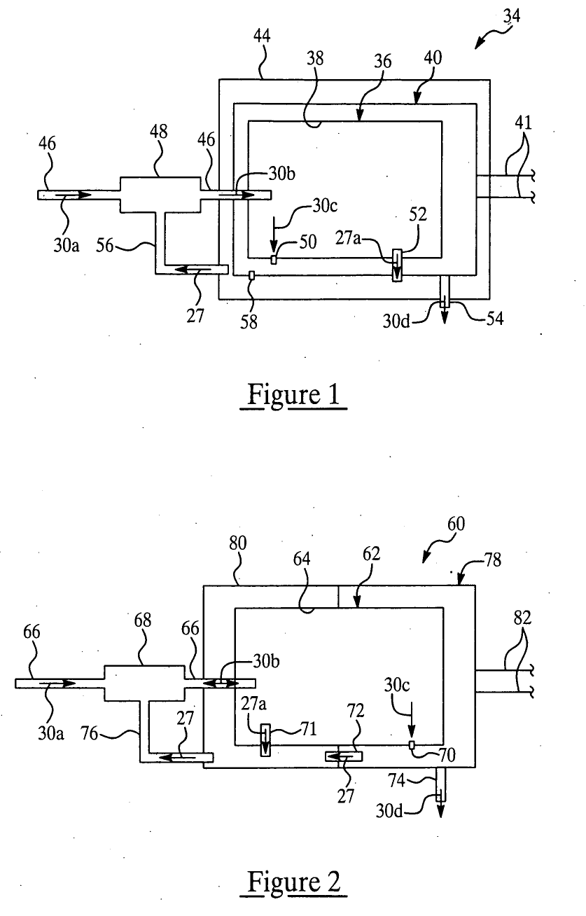

Referring initially to FIG. 1 of the drawings, an illustrative embodiment of the fuel cell enclosure of the present invention is generally indicated by reference numeral 34. The fuel cell enclosure 34 includes a stack module 36 which encloses a stack module interior 38. A fuel cell stack (not shown) is contained in the stack module interior 38.

An integrated condenser/muffler 40 at least partially surrounds or encapsulates the stack module 36. The integrated condenser/muffler 40 includes both a condenser (not shown) and a muffler (not shown). Coolant lines 41 typically distribute a liquid coolant (not shown) into and out of the integrated condenser/muffler 40. A DI (de-ionized) water tank 44, which contains a supply of DI (de-ionized) water (not shown), at least partially surrounds or encapsulates the integrated condenser/muffler 40. An air exhaust conduit 50 establishes communication between the stack module 36 and the integrated condenser/muffler 40. A water conduit 52 establishes fluid communication between the stack module 36 and the DI water tank 44 and extends through the integrated condenser/muffler 40. An air discharge conduit 54 extends from the integrated/condenser muffler 40, through the DI water tank 44. A distribution conduit 58 establishes communication between the integrated condenser/muffler 40 and the DI water tank 44.

An air intake conduit 46 is disposed in fluid communication with the stack module interior 38 of the stack module 36 and extends through the integrated condenser/muffler 40 and DI water tank 44. A humidifier 48, which may be conventional, is provided in the air intake conduit 46. A water return conduit 56 establishes fluid communication between the DI water tank 44 and the humidifier 48.

In operation of the fuel cell enclosure 34, intake air 30a is distributed through the air intake conduit 46 and into the humidifier 48. Moisture from the DI water tank 44 is added to the intake air 30a, and the resulting humidified air 30b flows from the humidifier 48 and into the fuel cell stack (not shown) contained in the stack module interior 38 of the stack module 36. As it passes through the fuel cell stack, the humidified air 30b maintains moisture of the polymer electrolyte membranes in the fuel cell stack, emerging from the stack as exhaust air 30c.

The exhaust air 30c is distributed from the fuel cell stack and stack module 36, respectively, and into the integrated condenser/muffler 40 through the air exhaust conduit 50. In the integrated condenser/muffler 40, excess moisture is removed from the moisture-rich and oxygen-depleted exhaust air 30c, forming dried air 30d. The dried air 30d is discharged from the integrated condenser/muffler 40, through the air discharge conduit 54 and into the atmosphere. The water 27 removed from the exhaust air 30c is distributed from the integrated condenser/muffler 40, through the distribution conduit 58 and into the DI water tank 44. This water 27 is distributed from the DI water tank 44, through the water return conduit 56 and into the humidifier 48. In the humidifier 48, the water 27 combines with and imparts moisture to the intake air 30a and is then distributed into the stack module 36 as humidified air 30b. Water 27a is distributed from the stack module 36, through the water conduit 52 and directly into the DI water tank 44.

It will be appreciated by those skilled in the art that the compact design of the integrated condenser/muffler 40 of the fuel cell enclosure 34 imparts enhanced package and weight efficiency to the design of the fuel cell enclosure 34 as well as enhanced thermal and noise insulation to the fuel cell stack contained in the stack module 36.

Referring next to FIG. 2 of the drawings, still another embodiment of the fuel cell enclosure of the present invention is generally indicated by reference numeral 60. The fuel cell enclosure 60 includes a stack module 62 having a stack module interior 64 which contains a fuel cell stack (not shown). An integrated condenser/muffler 78 and a DI water tank 80, which contains a supply of DI (de-ionized) water (not shown), at least partially surround or encapsulate the stack module 62 and are typically positioned in adjacent relationship to each other. Coolant lines 82 typically distribute a liquid coolant (not shown) into and out of the integrated condenser/muffler 78. An air exhaust conduit 70 establishes fluid communication between the stack module 62 and the integrated condenser/muffler 78. A water conduit 71 establishes communication between the stack module 62 and the DI water tank 80 to allow the passage of water 27a from the stack module 62 directly to the DI water tank 80. A distribution conduit 72 establishes fluid communication between the integrated condenser/muffler 78 and the DI water tank 80. An air discharge conduit 74 extends from the integrated condenser/muffler 78.

An air intake conduit 66 is disposed in fluid communication with the stack module interior 64 of the stack module 62. A humidifier 68, which may be conventional, is provided in the air intake conduit 66. A water return conduit 76 establishes fluid communication between the DI water tank 80 and the humidifier 68.

In operation of the fuel cell enclosure 60, intake air 30a is distributed through the air intake conduit 66 and into the humidifier 68. Humidified air 30b flows from the humidifier 68 and into and through the fuel cell stack (not shown) in the stack module interior 64 of the stack module 62. Exhaust air 30c, which contains by-product water from the fuel cell stack, is distributed from the fuel cell stack.

The exhaust air 30c is distributed from the stack module 62, through the air exhaust conduit 70 and into the integrated condenser/muffler 78. In the integrated condenser/muffler 78, water 27 is removed from the moisture-rich and oxygen-depleted exhaust air 30c to form dried air 30d. This dried air 30d is discharged from the integrated condenser/muffler 78, through the air discharge conduit 74 and into the atmosphere. The water 27 is distributed from the integrated condenser/muffler 78, through the distribution conduit 72 and into the DI water tank 80.

The water 27 is distributed from the DI water tank 80, through the water return conduit 76 and into the humidifier 68. In the humidifier 68, the water 27 combines with and imparts moisture to the intake air 30a and is then distributed into the stack module 62 as humidified air 30b, as was heretofore described. Water 27a is distributed directly from the stack module 62, through the water conduit 71 and into the DI water tank 80.

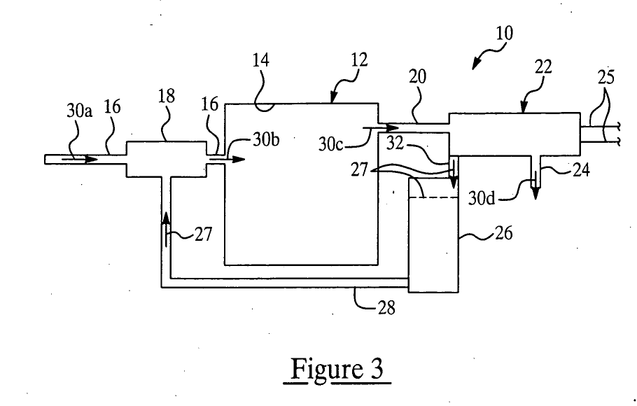

Referring next to FIG. 3 of the drawings, a third embodiment of the present invention is generally indicated by reference numeral 10. The fuel cell enclosure 10 includes a stack module 12 having a stack module interior 14 which contains a fuel cell stack (not shown).

An air intake conduit 16 is disposed in fluid communication with one side of the stack module 12. A humidifier 18, which may be conventional, is provided in the air intake conduit 16. An air exhaust conduit 20 extends from the opposite side of the stack module 12. An integrated condenser/muffler 22, which includes both a condenser (not shown) and a muffler (not shown), is disposed in fluid communication with the outlet end of the air exhaust conduit 20. Coolant lines 25 typically distribute a liquid coolant (not shown) into and out of the integrated condenser/muffler 22.

An air discharge conduit 24 extends from the integrated condenser/muffler 22. A DI (de-ionized) water tank 26, which contains a supply of DI (de-ionized) water 27, is disposed in fluid communication with the integrated condenser/muffler 22 through a distribution conduit 32. A water return conduit 28 connects the DI water tank 26 to the humidifier 18.

In operation of the fuel cell enclosure 10, intake air 30a is distributed through the air intake conduit 16 and into the humidifier 18, where moisture, typically from water 27 distributed from the DI water tank 26, as will be hereinafter described, is added to the intake air 30a. Humidified air 30b flows from the humidifier 18 and into the fuel cell stack (not shown) in the stack module interior 14 of the stack module 12. As it passes through the fuel cell stack, the humidified air 30b maintains the polymer electrolyte membranes at a moisture level which is sufficient to ensure optimum operation of the fuel cell stack. The resulting moisture-rich and oxygen-depleted exhaust air 30c is distributed from the stack module 12, through the air exhaust conduit 20 and into the integrated condenser/muffler 22.

As the exhaust air 30c passes through the integrated condenser/muffler 22, the condenser removes excess water 27 from the exhaust air 30c, forming dried air 30d. The dried air 30d is discharged from the integrated condenser/muffler 22, through the air discharge conduit 24 and into the atmosphere. The water 27 removed from the exhaust air 30c flows from the integrated condenser/muffler 22, through the distribution conduit 32 and into the DI water tank 26.

The water 27 discharged from the condenser/muffler 22 through the distribution conduit 32 collects in the DI water tank 26. The water 27 is distributed from the DI water tank 26, through the water return conduit 28 and to the humidifier 18, respectively. This can be carried out in any of various ways. For example, a pump (not shown) may be provided in the water return conduit 28, in which case the water 27 can be pumped from the DI water tank 26 to the humidifier 18. Alternatively, the water 27 can be pushed from the DI water tank 26 to the humidifier 18 using the pressure of the exhaust air 30c in the condenser/muffler 22, in combination with gravity. Still further in the alternative, in the case of a gas-to-gas humidifier 18, the air discharge conduit 24 may be connected to the humidifier 18 to supply partially-dried air to the humidifier 18. In that case, the water 27 collected from the condenser/muffler 22 would simply be removed through the distribution conduit 32. In the humidifier 18, the water 27 is combined with the intake air 30a to impart moisture to the intake air 30a, and is then distributed into the stack module 12 as humidified air 30b.

It will be appreciated by those skilled in the art that the integrated condenser/muffler 22 is characterized by enhanced space, weight and cost efficiency compared to the conventional separate condensers and mufflers.

While the preferred embodiments of the invention have been described above, it will be recognized and understood that various modifications can be made in the invention and the appended claims are intended to cover all such modifications which may fall within the spirit and scope of the invention.

What is claimed is:

1. A fuel cell system enclosure comprising:
a stack module having a stack module interior;
a humidifier provided in fluid communication with said stack module interior; and
an integrated condenser/muffler provided in fluid communication with said stack module interior.

2. The fuel cell system enclosure of claim 1 further comprising a DI water tank provided in fluid communication with said humidifier.

3. The fuel cell system enclosure of claim 2 further comprising a distribution conduit establishing fluid communication between said integrated condenser/muffler and said DI water tank.

4. The fuel cell system enclosure of claim 3 further comprising a water return conduit establishing fluid communication between said DI water tank and said humidifier.

5. The fuel cell system enclosure of claim 1 further comprising an air discharge conduit extending from said integrated condenser/muffler.

6. The fuel cell system enclosure of claim 1 further comprising a DI water tank disposed in fluid communication with said humidifier and said integrated condenser/muffler.

7. The fuel cell system enclosure of claim 6 further comprising a water return conduit establishing fluid communication between said DI water tank and said humidifier.

8. The fuel cell system enclosure of claim 7 further comprising a distribution conduit establishing fluid communication between said integrated condenser/muffler and said DI water tank.

9. A fuel cell system enclosure comprising:
a stack module having a stack module interior;
a humidifier provided in fluid communication with said stack module interior; and
an integrated condenser/muffler provided in fluid communication with said stack module interior and in at least partially surrounding relationship to said stack module.

10. The fuel cell system enclosure of claim 9 further comprising a DI water tank provided in fluid communication with said humidifier.

11. The fuel cell system enclosure of claim 10 wherein said DI water tank is disposed in at least partially surrounding relationship to said integrated condenser/muffler.

12. The fuel cell system enclosure of claim 11 further comprising a water conduit establishing fluid communication between said stack module interior and said DI water tank.

13. The fuel cell system enclosure of claim 11 further comprising a water return conduit establishing fluid communication between said DI water tank and said humidifier.

14. The fuel cell system enclosure of claim 11 further comprising a distribution conduit establishing fluid communication between said integrated condenser/muffler and said DI water tank.

15. The fuel cell system enclosure of claim 11 further comprising a water conduit establishing fluid communication between said stack module interior and said DI water tank and a water return conduit establishing fluid communication between said DI water tank and said humidifier.

16. The fuel cell system enclosure of claim 15 further comprising a distribution conduit establishing fluid communication between said integrated condenser/muffler and said DI water tank.

17. The fuel cell system enclosure of claim 16 further comprising an air discharge conduit provided in fluid communication with said integrated condenser/muffler.

18. A fuel cell system enclosure comprising:
a stack module having a stack module interior;
a humidifier provided in fluid communication with said stack module interior;
an integrated condenser/muffler provided in fluid communication with said stack module interior and in partially surrounding relationship to said stack module; and
a DI water tank provided in fluid communication with said humidifier and disposed in partially surrounding relationship to said stack module adjacent to said integrated condenser/muffler.

19. The fuel cell system enclosure of claim 18 further comprising a water conduit establishing fluid communication between said stock module interior and said DI water tank.

20. The fuel cell system enclosure of claim 18 further comprising a distribution conduit establishing fluid communication between said integrated condenser/muffler and said DI water tank.

21. The fuel cell system enclosure of claim 18 further comprising a water return conduit establishing fluid communication between said DI water tank and said humidifier.

22. The fuel cell system enclosure of claim 18 further comprising a water conduit establishing fluid communication between said stock module interior and said DI water tank and a distribution conduit establishing fluid communication between said integrated condenser/muffler and said DI water tank.

23. The fuel cell system enclosure of claim 22 further comprising a water return conduit establishing fluid communication between said DI water tank and said humidifier.

24. The fuel cell system enclosure of claim 23 further comprising an air discharge conduit disposed in fluid communication with said integrated condenser/muffler.

25. A method for operating a fuel cell system having one or more fuel cells, comprising:
providing an integrated condenser/muffler in communication with said one or more fuel cells; and
circulating exhaust air from said one or more fuel cells through said integrated condenser/muffler.

26. The method of claim 25 further comprising providing a humidifier in communication with said one or more fuel cells and distributing water in said exhaust air from said integrated condenser/muffler to said humidifier.

27. The method of claim 26 further comprising providing a water tank in communication with said integrated condenser/muffler and said humidifier and wherein said distributing water in said exhaust air from said integrated condenser/muffler to said humidifier comprises distributing said water from said integrated condenser/muffler to said water tank and from said water tank to said humidifier.
